(19) United States
(12) Patent Application Publication
(10) Pub. No.: US 2018/0214860 A1
(43) Pub. Date: Aug. 2, 2018

(54) HIGHLY STABLE PLATINUM GROUP METAL (PGM) CATALYST SYSTEMS

(71) Applicant: GM Global Technology Operations LLC, Detroit, MI (US)

(72) Inventors: Gongshin Qi, Troy, MI (US); Se H. Oh, Troy, MI (US); Ming Yang, Troy, MI (US); Ryan J. Day, Waterford, MI (US); Wei Li, Troy, MI (US)

(73) Assignee: GM Global Technology Operations LLC, Detroit, MI (US)

(21) Appl. No.: 15/419,263

(22) Filed: Jan. 30, 2017

(51) Int. Cl. B01J 37/10; B01J 23/42; B01J 23/44; B01J 21/04; B01J 35/10; B01J 37/08; B01J 37/02

(52) U.S. Cl. CPC B01J 37/10; B01J 23/42; B01J 23/44; B01J 21/04; B01J 35/1014; B01J 35/1038; B01J 37/08; B01J 37/02; B01J 35/1061; B01J 35/1042; B01J 35/1019

(57) ABSTRACT

A method of stabilizing a catalyst system includes hydrothermally treating an aluminum oxide catalyst support having ≥about 95 volume % of γ-Al₂O₃ phase by heating to a temperature of about 800° C. to about 1,200° C. in the presence of water. A majority of the γ-Al₂O₃ is converted to a stable alumina phase selected from the group consisting of: θ-Al₂O₃, δ-Al₂O₃, and combinations thereof to form a stabilized porous aluminum oxide support having an average surface area of ≥about 50 m²/g to ≤about 150 m²/g. A platinum group metal is then bound to a surface of the stable porous aluminum oxide support to form the stabilized catalyst systems.

### INTRODUCTION

This section provides background information related to the present disclosure which is not necessarily prior art.

The present disclosure relates to catalyst systems that are resistant to deactivation at high temperatures and improved methods for preparing catalyst systems that are resistant to deactivation at high temperatures.

Metal nanoparticles can make up the active sites of catalysts used in a variety of applications, such as for the production of fuels, chemicals and pharmaceuticals, and for emissions control from automobiles, factories, and power plants. Catalyst systems typically include a porous catalyst support material on which the one or more catalytically active compounds are dispersed with one or more optional promoters.

After continued use, especially at elevated temperatures, catalyst systems including supported metal particles lose catalytic activity due to sintering, e.g., thermal deactivation that occurs at high temperatures. Through various mechanisms, sintering results in several changes to the catalyst system. For example, catalyst metal particle size over a support can increase upon high-temperature exposure; hence resulting in a decrease in surface area for the active catalyst components. Such a particle size increase may occur via the “Ostwald ripening” mechanism, where atomic species emitted from metal nanoparticles move or diffuse across a support surface, or through a vapor phase coalescing with another nanoparticle, leading to nanoparticle growth. Deactivation can also occur as a result of structure changes in the catalyst support, where the pores of the catalyst support can collapse and potentially envelope or encapsulate catalyst particles dispersed on a surface.

After sintering or deactivation processes occur, then catalyst activity can decrease. Therefore, catalyst systems are often loaded with a sufficient amount of active metal/components to compensate for a loss of catalytic activity over time and to continue to have the ability to meet, for example, emissions standards over a long period of operation at high temperatures. Accordingly, there remains a need for improved catalysts that are stable at high temperatures and resist deactivation.

### SUMMARY

This section provides a general summary of the disclosure, and is not a comprehensive disclosure of its full scope or all of its features.

In certain aspects, the present disclosure relates to a method of stabilizing a catalyst system including hydrothermally treating an aluminum oxide catalyst support comprising greater than or equal to about 95 volume % of γ-Al₂O₃ phase by heating the support to a temperature of greater than or equal to about 700° C. to less than or equal to about 1,200° C. in air in the presence of water. The method further includes converting a majority of the γ-Al₂O₃ to a stable alumina phase selected from the group consisting of: θ-Al₂O₃, δ-Al₂O₃, and combinations thereof to form a stabilized porous aluminum oxide support having an average surface area of greater than or equal to about 50 m²/g to less than or equal to about 150 m²/g. A platinum group metal is bound to a surface of the stabilized porous aluminum oxide support to form the catalyst system.

In certain variations, the temperature is greater than or equal to about 850° C. and less than or equal to about 1,000° C.

In certain variations, the method further includes calcining the catalyst system including the platinum group metals and the catalyst support at a second temperature of greater than or equal to about 300° C. and less than or equal to about 650° C.

In certain variations, the platinum group metal includes a metal selected from the group consisting of: platinum (Pt), ruthenium (Ru), rhodium (Rh), palladium (Pd), osmium (Os), iridium (Ir), gold (Au), and combinations thereof. The binding of the platinum group metal to the stabilized porous aluminum oxide support may include impregnating one or more pores of the stabilized porous aluminum oxide support with a catalyst precursor solution, drying the metal precursor solution and the stabilized porous aluminum oxide support, and calcining the stabilized porous aluminum oxide support at a temperature of greater than or equal to about 550° C. in air

In certain variations, after the binding, a loading density of the platinum group metals on the stabilized porous aluminum oxide support is less than or equal to about 20% (weight/weight).

In certain variations, the stabilized porous aluminum oxide support optionally has an average pore size diameter of greater than or equal to about 5 nm and optionally an average pore volume of less than or equal to about 1 cm³/g.

In certain variations, a lightoff temperature of the catalyst system is reduced by greater than or equal to about 25° C. compared to a comparative catalyst system having the same amount of platinum group metals bound to a comparative porous aluminum oxide support.

In certain variations, a lightoff temperature of the catalyst system is reduced by greater than or equal to about 30° C. compared to a comparative catalyst system having the same amount of platinum group metals bound to a comparative porous aluminum oxide support.

In certain other aspects, the present disclosure relates to a catalyst system including a platinum group metal bound to a stabilized porous aluminum oxide support including greater than or equal to about 70% by volume of a stable alumina phase selected from the group consisting of: θ-Al₂O₃, δ-Al₂O₃, and combinations thereof. The stabilized porous aluminum oxide support has an average surface area of greater than or equal to about 50 m²/g to less than or equal to about 150 m²/g.

In certain variations, the platinum group metal includes a metal selected from the group consisting of: platinum (Pt), ruthenium (Ru), rhodium (Rh), palladium (Pd), osmium (Os), iridium (Ir), gold (Au), and combinations thereof.

In certain variations, the platinum group metal is a nanoparticle having a maximum diameter of greater than or equal to about 1 nm to less than or equal to about 20 nm after calcination.

In certain variations, the stabilized porous aluminum oxide support optionally has an average pore size diameter of greater than or equal to about 5 nm.

In certain variations, the stabilized porous aluminum oxide support optionally has an average pore volume of less than or equal to about 1 cm³/g.

In certain variations, the average surface area is less than or equal to about 115 m²/g.

In certain variations, a lightoff temperature of the catalyst system is reduced by greater than or equal to about 25° C. compared to a comparative catalyst system having the same amount of platinum group metals bound to a comparative porous aluminum oxide support.

In certain variations, a lightoff temperature of the catalyst system is reduced by greater than or equal to about 30° C. compared to a comparative catalyst system having the same amount of platinum group metals bound to a comparative porous aluminum oxide support.

In certain variations, a loading density of the platinum group metal on the stabilized porous aluminum oxide support is less than or equal to about 20% (weight/weight).

In certain variations, the stable alumina phase is present at greater than or equal to about 90% by volume in the stabilized porous aluminum oxide support.

In yet other aspects, the present disclosure relates to a catalyst system including a platinum group metal particle including a metal selected from the group consisting of: platinum (Pt), palladium (Pd), rhodium (Rh), and combinations thereof bound to a stabilized porous aluminum oxide support including greater than or equal to about 50% by volume of a stable alumina phase selected from the group consisting of: θ-Al₂O₃, δ-Al₂O₃, and combinations thereof. The stabilized porous aluminum oxide support has an average surface area of greater than or equal to about 50 m²/g to less than or equal to about 150 m²/g and a loading density of the platinum group metal particle on the stabilized porous aluminum oxide support is less than or equal to about 20% (weight/weight).

Further areas of applicability will become apparent from the description provided herein. The description and specific examples in this summary are intended for purposes of illustration only and are not intended to limit the scope of the present disclosure.

### DRAWINGS

The drawings described herein are for illustrative purposes only of selected embodiments and not all possible implementations, and are not intended to limit the scope of the present disclosure.

FIG. 1 shows a schematic representing a catalyst system having a fresh porous catalyst support including catalyst particles dispersed on a surface prior to any heat-induced processes occurring.

FIG. 2 shows a schematic representing the catalyst system including the fresh porous catalyst support having catalyst particles dispersed on the surface in FIG. 1 after high-temperature exposure, where heat causes the catalyst particle size to increase by sintering and heat also causes deactivation due to pore collapse of an unstable catalyst support that encapsulates a portion of the catalyst particles, therefore limiting access of exhaust gas to the active sites.

FIG. 3 shows a schematic representing a catalyst system according to certain aspects of the present disclosure including a stabilized porous catalyst support having platinum group metal (PGM) particles dispersed on a surface prior to any heat treatment.

FIG. 4 shows a schematic representing the catalyst system in FIG. 3 after sintering, which causes the catalyst particle size to increase, but the catalyst particles remain exposed to an that many include an exhaust gas.

FIG. 5 is a chart showing lightoff temperatures for catalyzing reactions with carbon monoxide and propene in a control catalyst system having a platinum (Pt) catalyst at 1.5 wt. % on a γ-phase fresh aluminum oxide support as compared to a stabilized aluminum oxide support comprising delta (δ) and theta (θ) phases with a Pt catalyst at 1.5 wt. % and a stabilized aluminum oxide support comprising delta (δ) and theta (θ) phases with a Pt catalyst at 0.75 wt. %. All Pt catalysts are aged at 650° C. in air for 2 hours prior to evaluation.

FIG. 6 is a chart showing lightoff performance temperatures for catalyzing reactions with carbon monoxide and propene in a control catalyst system having a palladium (Pd) catalyst at 1.5 wt. % on a γ-phase fresh aluminum oxide support as compared to a stabilized aluminum oxide support comprising delta (δ) and theta (θ) phases with a Pd catalyst at 0.75 wt. %. The control and stabilized aluminum oxide support sample are aged at 950° C. for 48 hours in 10% vol. H₂O in 90 vol. % air.

Corresponding reference numerals indicate corresponding parts throughout the several views of the drawings.

### DETAILED DESCRIPTION

Example embodiments are provided so that this disclosure will be thorough, and will fully convey the scope to those who are skilled in the art. Numerous specific details are set forth such as examples of specific compositions, components, devices, and methods, to provide a thorough understanding of embodiments of the present disclosure. It will be apparent to those skilled in the art that specific details need not be employed, that example embodiments may be embodied in many different forms and that neither should be construed to limit the scope of the disclosure. In some example embodiments, well-known processes, well-known device structures, and well-known technologies are not described in detail.

The terminology used herein is for the purpose of describing particular example embodiments only and is not intended to be limiting. As used herein, the singular forms “a,” “an,” and “the” may be intended to include the plural forms as well, unless the context clearly indicates otherwise. The terms “comprises,” “comprising,” “including,” and “having,” are inclusive and therefore specify the presence of stated features, elements, compositions, steps, integers, operations, and/or components, but do not preclude the presence or addition of one or more other features, integers, steps, operations, elements, components, and/or groups thereof. Although the open-ended term “comprising,” is to be understood as a non-restrictive term used to describe and claim various embodiments set forth herein, in certain aspects, the term may alternatively be understood to instead be a more limiting and restrictive term, such as “consisting of” or “consisting essentially of.” Thus, for any given embodiment reciting compositions, materials, components, elements, features, integers, operations, and/or process steps, the present disclosure also specifically includes embodiments consisting of, or consisting essentially of, such recited compositions, materials, components, elements, features, integers, operations, and/or process steps. In the case of “consisting of,” the alternative embodiment excludes any additional compositions, materials, components, elements, features, integers, operations, and/or process steps, while in the case of “consisting essentially of,” any additional compositions, materials, components, elements, features, integers, operations, and/or process steps that materially affect the basic and novel characteristics are excluded from such an embodiment, but any compositions, materials, components, elements, features, integers, operations, and/or process steps that do not materially affect the basic and novel characteristics can be included in the embodiment.

Any method steps, processes, and operations described herein are not to be construed as necessarily requiring their performance in the particular order discussed or illustrated, unless specifically identified as an order of performance. It is also to be understood that additional or alternative steps may be employed, unless otherwise indicated.

When a component, element, or layer is referred to as being “on,” “engaged to,” “connected to,” or “coupled to” another element or layer, it may be directly on, engaged, connected or coupled to the other component, element, or layer, or intervening elements or layers may be present. In contrast, when an element is referred to as being “directly on,” “directly engaged to,” “directly connected to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

Although the terms first, second, third, etc. may be used herein to describe various steps, elements, components, regions, layers and/or sections, these steps, elements, components, regions, layers and/or sections should not be limited by these terms, unless otherwise indicated. These terms may be only used to distinguish one step, element, component, region, layer or section from another step, element, component, region, layer or section. Terms such as “first,” “second,” and other numerical terms when used herein do not imply a sequence or order unless clearly indicated by the context. Thus, a first step, element, component, region, layer or section discussed below could be termed a second step, element, component, region, layer or section without departing from the teachings of the example embodiments.

Spatially or temporally relative terms, such as “before,” “after,” “inner,” “outer,” “beneath,” “below,” “lower,” “above,” “upper,” and the like, may be used herein for ease of description to describe one element or feature's relationship to another element(s) or feature(s) as illustrated in the figures. Spatially or temporally relative terms may be intended to encompass different orientations of the device or system in use or operation in addition to the orientation depicted in the figures.

Throughout this disclosure, the numerical values represent approximate measures or limits to ranges to encompass minor deviations from the given values and embodiments having about the value mentioned as well as those having exactly the value mentioned. Other than in the working examples provided at the end of the detailed description, all numerical values of parameters (e.g., of quantities or conditions) in this specification, including the appended claims, are to be understood as being modified in all instances by the term “about” whether or not “about” actually appears before the numerical value. “About” indicates that the stated numerical value allows some slight imprecision (with some approach to exactness in the value; approximately or reasonably close to the value; nearly). If the imprecision provided by “about” is not otherwise understood in the art with this ordinary meaning, then “about” as used herein indicates at least variations that may arise from ordinary methods of measuring and using such parameters. For example, “about” may comprise a variation of less than or equal to 5%, optionally less than or equal to 4%, optionally less than or equal to 3%, optionally less than or equal to 2%, optionally less than or equal to 1%, optionally less than or equal to 0.5%, and in certain aspects, optionally less than or equal to 0.1%.

In addition, disclosure of ranges includes disclosure of all values and further divided ranges within the entire range, including endpoints and sub-ranges given for the ranges.

Example embodiments will now be described more fully with reference to the accompanying drawings.

In various aspects, the present disclosure provides stabilized catalyst systems and methods for preparing stabilized catalyst systems. In this manner, highly active catalyst systems are provided that have good resistance to aging and long-term stability despite exposure to high temperatures during catalyst operation. Accordingly, the present technology minimizes catalyst deactivation processes, including PGM particle growth and encapsulation processes that occur after exposure to high-temperature during long-term catalyst operation.

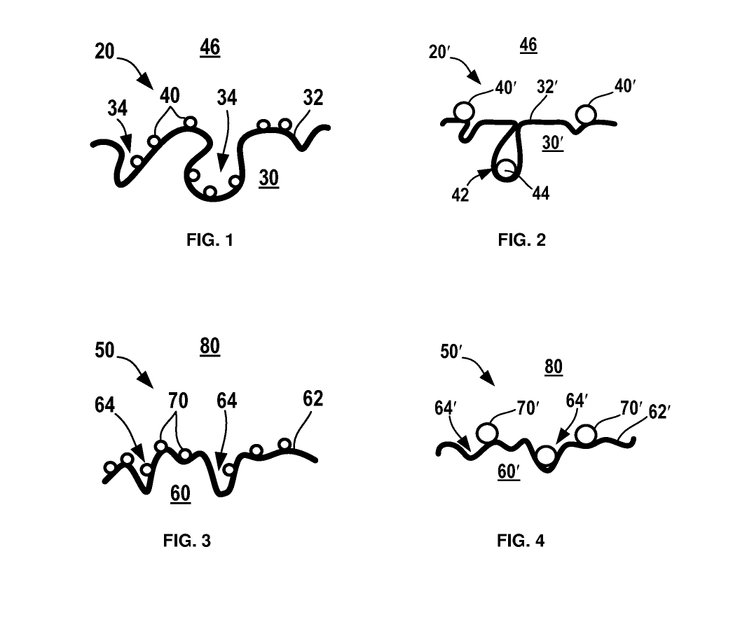

By way of background, FIG. 1 shows a schematic representing a comparative catalyst system 20 including a porous catalyst support 30. The porous catalyst support 30 has a surface 32 that defines a plurality of pores 34. The surface 32 also has a plurality of catalyst particles 40 dispersed thereon. The catalyst particles 40 are either directly or indirectly coupled or bound to the surface 32. The comparative catalyst system 20 is shown prior to any heat-induced processes occurring, like sintering or heat deactivation that can occur after exposure of the catalyst system 20 to heat associated with catalyst operating conditions.

In FIG. 2, a comparative catalyst system 20′ is shown after exposure to heat that is associated with catalyst operation that results in heat deactivation and sintering. Typical catalyst system operating temperatures may vary depending on the application, but may range from about 100° to about 1100° C., by way of example.

The exposure to heat causes the plurality of catalyst particles 40′ to increase in particle size during a sintering process, as compared to an initial particle size of the plurality of catalyst particles 40 shown in FIG. 1. Furthermore, it has been discovered in conjunction with certain aspects of the present disclosure that for catalyst supports 30 comprising aluminum oxide, certain phases of alumina present in comparative catalyst supports may become unstable when exposed to high-temperature encountered during certain catalyst operations, as described further below. Thus, such catalyst supports 30 comprising unstable alumina phases can suffer from collapse of pores when exposed to high-temperature associated with catalyst operating conditions. Thus, as shown in FIG. 2, an unstable catalyst support 30′ has at least one representative collapsed pore 42. The collapsed pore 42 occurs when invaginations arise in the unstable catalyst support 30 resulting in possible pore closure and collapse. Therefore, exposed regions of the support surface 32′ no longer include the interior regions of the collapsed pore 42. As shown, a catalyst particle 44 has been trapped in the collapsed pore 42. The catalyst particle 44 is no longer exposed to an external gaseous environment 46 for reaction on the catalyst system 20′. When this pore collapses and deactivation occurs on a wider scale at operating temperatures, a surface area of the porous catalyst support 30′ decreases, resulting in catalyst deactivation and loss of activity.

FIG. 3 shows a schematic representing a stabilized catalyst system 50 according to certain aspects of the present disclosure. The stabilized catalyst system 50 includes a stable porous catalyst support 60 shown before sintering that occurs during catalyst operation. The stable porous catalyst support 60 has a surface 62 that defines a plurality of pores 64. The surface 62 also has a plurality of catalyst particles 70 dispersed thereon. The catalyst particles 70 are either directly or indirectly coupled or bound to the surface 62. The stabilized catalyst system 50 is shown prior to any heat-induced processes occurring, like sintering. The stable porous catalyst support 60 comprises aluminum oxide. As will be described further herein, the stable porous catalyst support 60 is formed by pretreatment of the catalyst support 30 so that it comprises one or more stable alumina phases.

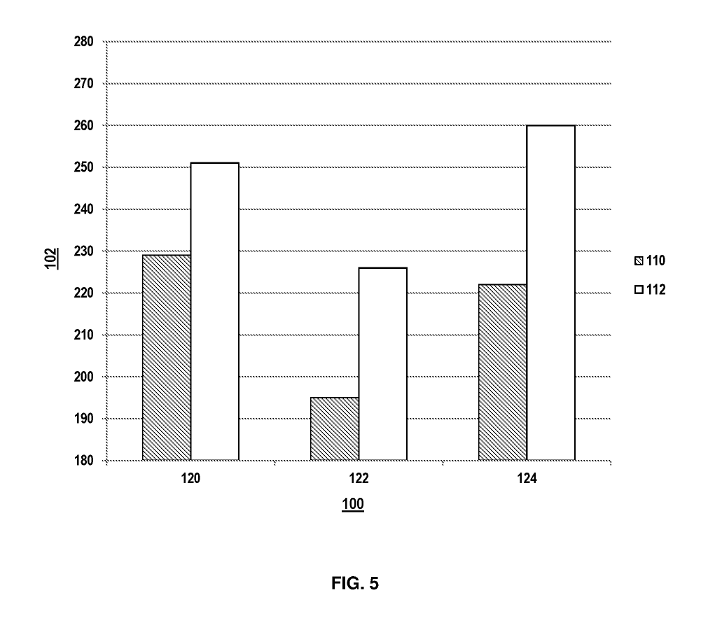

FIG. 4 shows a schematic representing the stabilized catalyst system 50 in FIG. 3 after catalyst sintering that occurs during catalyst operating. After exposure to heat, a plurality of catalyst particles 70′ may increase in particle size during a sintering process as compared to the initial particle size of the plurality of catalyst particles 70 shown in FIG. 3. It should be noted that sintering and coalescence of the plurality of catalyst particles 70′ may be minimized in the stable catalyst system 50 and may not occur to the extent shown. A surface 62′ and pores 64′ of heat-treated stable porous catalyst support 60′ remain stable with minimal or no collapsing pores, as occurs in comparison in the comparative catalyst system 20′ after exposure to high-temperature during catalyst operations. While the surface area of surface 62′ may decrease in the heat-treated stable porous catalyst support 60′, pore collapse is minimized. Furthermore, the heat-treated stable porous catalyst support 60′ reduces defects on the surface 62′ to enable a more even and uniform distribution of catalyst particles 70′, which, in turn, reduces any sintering-induced particle growth. In this manner, the catalyst particles 70′ remain exposed to an external environment 80 and retain high activity levels. Catalyst systems are thus provided by certain aspects of the present disclosure that are resistant to deactivation due to sintering.

Thus, in certain aspects, the present disclosure provides methods of stabilizing a catalyst system. A catalyst support material may comprise aluminum oxide or alumina (Al₂O₃). In various embodiments, the catalyst support is highly porous. The catalyst support may have greater than about 40% by volume pores, optionally greater than about 50% by volume pores, optionally greater than about 60% by volume pores, optionally greater than about 70% by volume pores, optionally greater than about 80% by volume pores, and in certain aspects, optionally greater than about 85% by volume pores.

The catalyst support may be in the form of a plurality of particulates (e.g., a powder). In such a variation, the support may have an average particle diameter of greater than or equal to about 0.8 μm to less than or equal to about 5 μm, greater than or equal to 1 μm to less than or equal to about 4 μm, greater than or equal to 1.5 μm to less than or equal to about 3.5 μm, or greater than or equal to 2 μm to less than or equal to about 3 μm, such as a diameter of about 0.8 μm, about 1 μm, about 1.5 μm, about 2 μm, about 2.5 μm, about 3 μm, about 3.5 μm, about 4 μm, about 4.5 μm, or about 5 μm. When the catalyst is combined with the catalyst support particles, they may be coated onto a monolith structure (e.g., a honeycomb structure) as a washcoat layer.

The catalyst support material may further comprise dopants or small amounts of other ceramic materials. For example, other ceramic materials may include metal oxides, such as cerium oxide (CeO₂), zirconium oxide (ZrO₂), titanium dioxide (TiO₂), silicon dioxide (SiO₂), magnesium oxide (MgO), zinc oxide (ZnO), barium oxide (BaO), potassium oxide (K₂O), sodium oxide (Na₂O), calcium oxide (CaO), lanthanum oxide (La₂O₃), and combinations thereof. The dopants may be selected from the group consisting of barium (Ba), cerium (Ce), lanthanum (La), phosphorus (P), and combinations thereof. In certain aspects, the catalyst support material comprises greater than or equal to about 90% by mass of aluminum oxide (Al₂O₃), optionally greater than or equal to about 95% by mass, optionally greater than or equal to about 97% by mass, optionally greater than or equal to about 98% by mass, and in certain variations, optionally greater than or equal to about 99% by mass Al₂O₃. In certain aspects, the catalyst support material may comprise 100% by mass of aluminum oxide (Al₂O₃).

Prior to any heat treatment in accordance with the present disclosure, the as-received catalyst support material may comprise primarily γ-Al₂O₃ phase. For example, the aluminum oxide catalyst support may comprise greater than or equal to about 75 volume % of γ-Al₂O₃ phase, optionally greater than or equal to about 80 volume % of γ-Al₂O₃ phase, optionally greater than or equal to about 85 volume % of γ-Al₂O₃ phase, optionally greater than or equal to about 90 volume % of γ-Al₂O₃ phase, optionally greater than or equal to about 95 volume % of γ-Al₂O₃ phase, optionally greater than or equal to about 97 volume % of γ-Al₂O₃ phase, and in certain variations, optionally greater than or equal to about 98 volume % of γ-Al₂O₃ phase. The γ-Al₂O₃ phase can become unstable when exposed to high temperatures during catalyst operation, thus suffering from aging, collapse, and deactivation as discussed above in the context of FIGS. 1 and 2.

Conventionally, the catalyst support may have a plurality of platinum group metal (PGM) particles disposed thereon. For example, the catalyst may comprise one or more platinum group metals, such as ruthenium (Ru), rhodium (Rh), palladium (Pd), osmium (Os), iridium (Ir), platinum (Pt), gold (Au), or combinations thereof. In one variation, the PGM catalyst particle may comprise platinum (Pt), palladium (Pd), rhodium (Rh), or mixtures thereof. In other aspects, the catalyst particles may include other metals, such as copper (Cu), silver (Ag), iron (Fe), nickel (Ni), manganese (Mn), sodium (Na), potassium (K), magnesium (Mg), calcium (Ca), barium (B a), or combinations thereof.

In certain variations, the catalyst particle may have a maximum diameter of greater than or equal to about 1 nm to less than or equal to about 20 nm, such as a diameter of about 1 nm, about 2 nm, about 3 nm, about 4 nm, about 5 nm, about 6 nm, about 7 nm, about 8 nm, about 9 nm, about 10 nm, or about 20 nm.

The catalyst particles may have a loading density on the catalyst support of greater than or equal to about 0.25% (w/w) to less than or equal to about 20% (w/w), optionally greater than or equal to about 0.25% (w/w) to less than or equal to about 10% (w/w), optionally greater than or equal to about 0.25% (w/w) to less than or equal to about 5% (w/w), optionally greater than or equal to about 0.25% (w/w) to less than or equal to about 2% (w/w), such as a loading density of about 0.25% (w/w), about 0.5% (w/w), about 0.75% (w/w), about 1% (w/w), about 2% (w/w), about 3% (w/w), about 4% (w/w), about 5% (w/w), about 10% (w/w), about 15% (w/w), or about 20% (w/w).

In certain aspects, the platinum group metal is bound to the stabilized porous aluminum oxide support by impregnating one or more pores in the catalyst support with a catalyst metal precursor solution. For example, the pores of the stabilized catalyst support may be impregnated with a metal precursor solution, followed by drying (e.g., for 7-12 hours), and then calcining. The calcining of the stabilized catalyst support may be conducted at a temperature of greater than or equal to about 300° C. in air.

After binding the catalyst particles to the catalyst support, the catalyst support and catalyst particles may then be sintered at relatively low temperatures (depending on the composition of the platinum group metal, these temperatures may be less than about 700° C.). The catalyst system having the calcined catalyst support and particles is then used in service at typical operating conditions, where it can suffer from aging and deactivation.

In accordance with certain aspects of the present disclosure, prior to binding a platinum group metal with the catalyst support or calcining/sintering, the catalyst support is pretreated to form one or more stable phases that can minimize or avoid the consequences of aging. In certain aspects, the aluminum oxide catalyst support comprising the γ-Al₂O₃ phase is heated to a temperature of greater than or equal to about 800° C. to less than or equal to about 1,200° C., optionally greater than or equal to about 850° C. and less than or equal to about 1,100° C. The heating may be part of a hydrothermal treatment process that occurs in the presence of water. The heating step may be conducted for greater than or equal to about 10 hours and in certain variations, optionally greater than or to about 15 hours, optionally greater than or to about 20 hours, and in certain variations, optionally greater than or to about 24 hours.

The heating step converts a majority of the γ-Al₂O₃ to more stable alumina phases. A majority means greater than or equal to about 50% by volume, optionally greater than or equal to about 60% by volume, optionally greater than or equal to about 70% by volume, optionally greater than or equal to about 75% by volume, optionally greater than or equal to about 80% by volume, optionally greater than or equal to about 85% by volume, optionally greater than or equal to about 90% by volume, optionally greater than or equal to about 95% by volume, optionally greater than or equal to about 97% by volume, optionally greater than or equal to about 98% by volume, and in certain variations, optionally greater than or equal to about 99% by volume of the γ-Al₂O₃ is converted to a stable alumina phase. The stable alumina phase may be selected from the group consisting of: θ-Al₂O₃, δ-Al₂O₃, and combinations thereof.

In certain aspects, the heating is a hydrothermal treatment of the aluminum oxide catalyst support, where the support is heated in the presence of water. For example, the hydrothermal treatment may include heating the catalyst in an environment having less than or equal to about 30% by volume of water and a balance air (primarily nitrogen and oxygen). In certain variations, an amount of water in the atmosphere used during heating may be greater than or equal to about 0.5% by volume to less than or equal to about 25% by volume, optionally greater than or equal to about 1% by volume to less than or equal to about 15% by volume, optionally greater than or equal to about 8% by volume to less than or equal to about 12% by volume, for example, about 10% by volume of water in one variation. In one example embodiment, the hydrothermal treatment may occur at 1,000° C. for 20-24 hours in an environment comprising 10% by volume water and 90% by volume air at one atmosphere (atm) of pressure.

In this manner, a stabilized porous aluminum oxide support is formed by a heat treatment, which transforms a majority of the γ-Al₂O₃ to a stable alumina phase selected from the group consisting of: θ-Al₂O₃, δ-Al₂O₃, and combinations thereof. The stabilized porous aluminum oxide support may have an average surface area of less than or equal to about 150 m²/g, optionally less than or equal to about 125 m²/g, optionally less than or equal to about 115 m²/g, and in certain variations, less than or equal to about 100 m²/g, as measured “total surface area” via the Brunauer-Emmet-Teller (BET) method using nitrogen (N₂) sorption. In certain aspects, the stabilized porous aluminum oxide support may have an average surface area of greater than or equal to about 50 m²/g to less than or equal to about 150 m²/g, optionally greater than or equal to about 50 m²/g to less than or equal to about 125 m²/g, and in certain aspects, optionally greater than or equal to about 75 m²/g to less than or equal to about 115 m²/g.

In certain aspects, the stabilized porous aluminum oxide support has an average pore size diameter of greater than or equal to about 5 nm, optionally greater than or equal to about 10 nm, optionally greater than or equal to about 15 nm, and in certain aspects, optionally greater than or equal to about 20 nm. In one variation, the stabilized aluminum oxide support may have an average pore size diameter of greater than or equal to about 15 nm to less than or equal to about 100 nm. Unless otherwise indicated, “pore size” refers to an average or median value including both the internal and external pore diameter sizes. The terms “pore” and “pores” refers to pores of various sizes, including so-called “macropores” (pore size greater than about 50 nanometers (nm) diameter), “mesopores” (pore sizes having diameter between about 2 nm and about 50 nm), and “micropores” (pore sizes less than about 2 nm). While not limiting the present disclosure to any particular theory, it is believed that the pretreatment heating of the aluminum oxide catalyst support causes a phase change that reduces the presence of micropores, which have the greatest tendency to collapse. Thus, the reduction of the presence of micropores in the stabilized porous aluminum oxide support reduces the propensity for the platinum gas metal particles (PGM) to be encapsulated by the micropore collapse and thus minimizes catalyst deactivation. By way of non-limiting example, after hydrothermal treatment, approximately 10 to 30% of the micropores in the stabilized porous aluminum oxide support remain, as compared to an initial amount of micropores prior to the hydrothermal treatment. In certain aspects, the stabilized porous aluminum oxide support has an average pore volume of less than or equal to about 1 cm³/g, optionally less than or equal to about 0.75 cm³/g.

Furthermore, the conversion of the alumina from the γ-Al₂O₃ to the θ-Al₂O₃ and/or δ-Al₂O₃ phases enables a more even and uniform distribution of the plurality of platinum group metal (PGM) catalyst particles on the surface of the stabilized catalyst support. More uniformly distributed PGM catalyst particles results in a slower PGM sintering rate. A more uniform support surface formed by the heat treatment creates a stabilized support having fewer defect sites, which in turn, can lead to more uniform PGM particle size distribution and thus slower particle growth rate according to an Ostwald ripening mechanism. Thus, the stabilized porous aluminum oxide support formed after pretreatment comprises a stable phase (θ-Al₂O₃, δ-Al₂O₃, or mixtures thereof) that serves to decrease PGM particle growth and minimize PGM encapsulation, so as to maximize the PGM utilization efficiency.

In certain aspects, the PGM catalyst particles may be resistant to sintering and may have a relatively high catalyst metal dispersion. “Catalyst metal dispersion” refers to a fraction of catalyst metal surface sites exposed to the reactant gas, thus participating in the catalytic reaction. Therefore, a catalyst system with a high dispersion will have smaller and more highly dispersed metal catalyst particles relative to a catalyst system with a low dispersion. Relative to a catalyst system equivalent to the catalyst system described herein, an untreated catalyst system has a dispersion of about 17% after aging at a temperature of about 650° C. for a time period of about 2 hours. A treated catalyst system that resists sintering and is prepared in accordance with the present disclosure has a dispersion of about 40%, after the same catalyst aging process.

The methods may further include heating the catalyst system comprising the platinum group metal and the stabilized porous aluminum oxide support at a temperature of greater than or equal to about 300° C. and less than or equal to about 1,000° C., depending on the catalyst metal that is present. For example, the further heating may be conducted at greater than or equal to about 650° C. and less than or equal to about 1,000° C. in certain variations.

In certain aspects, a stable catalyst system having a stabilized porous aluminum oxide support can reduce a catalyst PGM particle loading requirement. For example, relative to a comparative catalyst system having the same catalyst and untreated aluminum oxide support material (i.e., no pretreatment step to form the stabilized porous aluminum oxide support having the stable alumina phases), the present technology may reduce a catalyst metal loading requirement by greater than or equal to about 30%, greater than or equal to about 40%, greater than or equal to about 50%, greater than or equal to about 60%, greater than or equal to about 70%, greater than or equal to about 80% or greater than or equal to about 90%, such as from about 30% to about 90%, from about 40% to about 80%, from about 50%, to about 80%, from about 60% to about 80%, or from about 70% to about 80%. In other aspects, relative to a comparative catalyst system having the same catalyst and untreated aluminum oxide support material (as well as the same catalyst amount), the present technology may reduce a lightoff temperature by greater than or equal to about 20° C., optionally greater than or equal to about 25° C., and in certain variations, optionally reduce a lightoff temperature from greater than or equal to about 30° C.

Embodiments of the present technology are further illustrated through the following non-limiting examples.

### Example 1

In Example 1, lightoff temperatures for platinum catalyst systems are compared. A control 120 is formed from an aluminum oxide (alumina-Al₂O₃) powder having a plurality of platinum (Pt) nanoparticles bound on the surface thereof at a concentration of 1.5 weight % Pt. For the fresh untreated Al₂O₃, the major phase of the alumina is gamma (γ) as confirmed by X-ray diffraction (XRD).

A first sample 122 is prepared in accordance with certain aspects of the present disclosure formed from a pretreated stabilized aluminum oxide (alumina-Al₂O₃) powder that is hydrothermally treated at 1,000° C. for 20 hours in a mixture of 10 vol. % H₂O and 90 vol. % air. For the hydrothermally treated alumina, the Al₂O₃ is a mixture of delta (δ) and theta (θ) phases as confirmed by XRD. After cooling, a plurality of platinum (Pt) nanoparticles is bound to the surface of the pretreated Al₂O₃ at a concentration of 1.5 weight % Pt.

A second sample 124 is prepared in accordance with certain aspects of the present disclosure formed from a pretreated stabilized aluminum oxide (alumina-Al₂O₃) powder that is hydrothermally treated at 1,000° C. for 20 hours in a mixture of 10 vol. % H₂O and 90 vol. % air. For the hydrothermally treated alumina, the Al₂O₃ is a mixture of delta (δ) and theta (θ) phases as confirmed by XRD. After cooling, a plurality of platinum (Pt) nanoparticles is bound to the surface of the pretreated Al₂O₃ at a concentration of 0.75 weight % Pt. Table 1 below shows the general properties of the alumina supports (both the fresh untreated support used in control 120 and the hydrothermally treated stable support prepared in accordance with certain aspects of the present disclosure).

TABLE 1

| | Surface Area | Pore Volume | Average Pore |
|---|---|---|---|
| | (m²/g) | (cc/g) | Size (nm) |
| Fresh/untreated | 195 | 0.88 | 18 |
| Alumina (comprising | | | |
| gamma (γ) phase) | | | |
| Hydrothermally Treated | 114 | 0.78 | 28 |
| Stabilized Alumina | | | |
| (comprising delta (δ) and | | | |
| theta (θ) phases) | | | |

In the control 120 with 1.5% Pt on the fresh/untreated alumina support, a dispersion level is about 17%. In comparison, in second sample 124, the hydrothermally treated stable alumina support system having 0.75 weight % Pt has an improved platinum dispersion level of about 40%.

Each of the control 120, first sample 122, and second sample 124 is aged at 650° C. for 2 hours in air. Then, the lightoff performance is compared, as shown in FIG. 5. The x-axis 100 shows each of the control 120, first sample 122, and second sample 124. The y-axis 102 shows lightoff temperature (° C.). As seen in FIG. 5, a metric used to evaluate activity is T₅₀ (lightoff temperature), which is the temperature at which 50% of the CO and C₃H₆ in the feed stream are being oxidized over the catalyst, respectively. Series 110 shows the catalyst lightoff temperatures for carbon monoxide (CO), while series 112 shows the catalyst lightoff temperatures for propene (C₃H₆). The lower the lightoff temperature, the higher the catalyst performance.

As can be seen, control 120 with the fresh/untreated Al₂O₃ having a γ-phase with 1.5% Pt exhibits a CO lightoff temperature of 229° C. and a C₃H₆ lightoff temperature of 251° C. Comparatively, first sample 122 has the same catalyst loading at 1.5% Pt, but has a stabilized Al₂O₃ support with delta (δ) and theta (θ) phases, and shows reductions in lightoff temperature of about 34 and 25° C. for CO (lightoff temperature of 195° C.) and C₃H₆ (lightoff temperature of 226° C.), respectively. By reducing the PGM loading in half to 0.75% Pt, the lightoff temperatures are approximately the same as the control, namely a CO lightoff temperature of 222° C. and a C₃H₆ lightoff temperature of 260° C. Thus, comparable lightoff performance can be achieved at one-half the Pt catalyst loading when the stabilized Al₂O₃ support is used.

### Example 2

In Example 2, lightoff temperatures for palladium catalyst systems are compared. A control 170 is formed from an untreated aluminum oxide (alumina-Al₂O₃) powder having a plurality of palladium (Pd) nanoparticles bound on the surface thereof at a concentration of 1.5 weight % Pd. The fresh/untreated Al₂O₃ used has a major phase of gamma (γ) alumina as confirmed by X-ray diffraction (XRD).

A third sample 172 is prepared in accordance with certain aspects of the present disclosure formed from a pretreated stabilized aluminum oxide (alumina-Al₂O₃) powder that is hydrothermally treated at 1,000° C. for 20 hours in a mixture of 10 vol. % H₂O and 90 vol. % air. For the hydrothermally treated alumina, the Al₂O₃ is a mixture of delta (δ) and theta (θ) phases. After cooling, a plurality of bound palladium (Pd) nanoparticles is bound to the surface of the pretreated Al₂O₃ at a concentration of 0.75 weight % Pd.

In the control 170 with 1.5% Pd on the fresh untreated alumina support, a dispersion level is about 8.4%. In comparison, in the third sample 172, the hydrothermally treated stable alumina support system having 0.75 weight % Pd has an improved palladium dispersion level of about 20%.

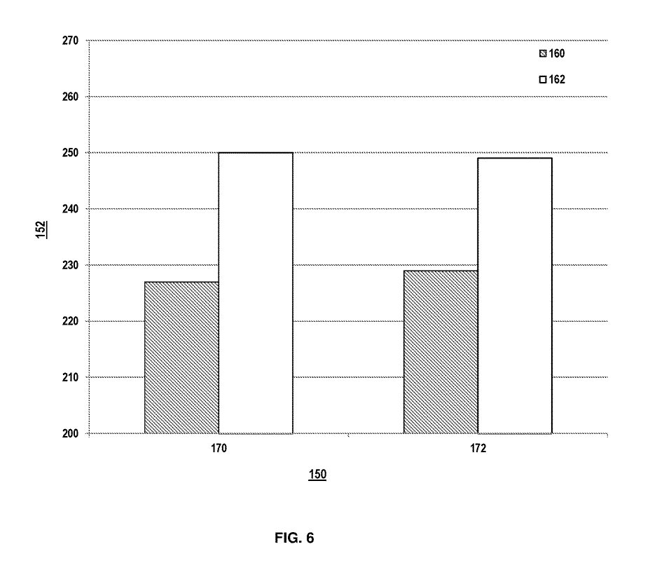

Control 170 and the third sample 172 are aged at 950° C. for 48 hours in 10% vol. H₂O in 90 vol. % air. Then, the lightoff performance, as measured by T₅₀, is compared, as shown in FIG. 6. The x-axis 150 shows control 170 and third sample 172. The y-axis 152 shows lightoff temperature (° C.). Series 160 shows the catalyst lightoff temperatures for carbon monoxide (CO) oxidation, while series 162 shows the catalyst lightoff temperatures for propene (C₃H₆) oxidation. As can be seen, control 170 with the fresh untreated Al₂O₃ having a γ-phase with 1.5% Pd exhibits a CO lightoff temperature of 227° C. and a C₃H₆ lightoff temperature of 250° C. Comparatively, the PGM loading is reduced in half to 0.75% Pd in the third sample 172, where the lightoff temperatures are approximately the same as the control, namely a CO lightoff temperature of 229° C. and a C₃H₆ lightoff temperature of 249° C. Thus, comparable performance can be achieved at one-half the Pd catalyst loading when the stabilized Al₂O₃ support is used in the third sample 172.

The foregoing description of the embodiments has been provided for purposes of illustration and description. It is not intended to be exhaustive or to limit the disclosure. Individual elements or features of a particular embodiment are generally not limited to that particular embodiment, but, where applicable, are interchangeable and can be used in a selected embodiment, even if not specifically shown or described. The same may also be varied in many ways. Such variations are not to be regarded as a departure from the disclosure, and all such modifications are intended to be included within the scope of the disclosure.

What is claimed is:

1. A method of stabilizing a catalyst system comprising:
hydrothermally treating an aluminum oxide catalyst support comprising greater than or equal to about 95 volume % of γ-Al₂O₃ phase by heating the support to a temperature of greater than or equal to about 700° C. to less than or equal to about 1,200° C. in air in the presence of water;
converting a majority of the γ-Al₂O₃ to a stable alumina phase selected from the group consisting of: θ-Al₂O₃, δ-Al₂O₃, and combinations thereof to form a stabilized porous aluminum oxide support having an average surface area of greater than or equal to about 50 m²/g to less than or equal to about 150 m²/g; and
binding a platinum group metal to a surface of the stabilized porous aluminum oxide support to form the catalyst system.

2. The method of claim 1, wherein the temperature is greater than or equal to about 850° C. and less than or equal to about 1,100° C.

3. The method of claim 1, further comprising calcining the catalyst system comprising the platinum group metal dispersed on the stabilized porous aluminum oxide support at a second temperature of greater than or equal to about 300° C. and less than or equal to about 650° C.

4. The method of claim 1, wherein the platinum group metal comprises a metal selected from the group consisting of platinum (Pt), ruthenium (Ru), rhodium (Rh), palladium (Pd), osmium (Os), iridium (Ir), gold (Au), and combinations thereof and the binding of the platinum group metal to the stabilized porous aluminum oxide support comprises impregnating one or more pores of the stabilized porous aluminum oxide support with a catalyst precursor solution, drying the catalyst precursor solution and stabilized porous aluminum oxide support, and calcining the stabilized porous aluminum oxide support at a temperature of greater than or equal to about 550° C. in air.

5. The method of claim 1, wherein after the binding, a loading density of the platinum group metal on the stabilized porous aluminum oxide support is less than or equal to about 20% (weight/weight).

6. The method of claim 1, wherein the stabilized porous aluminum oxide support has an average pore size diameter of greater than or equal to about 5 nm and an average pore volume of less than or equal to about 0.75 cm³/g.

7. The method of claim 1, wherein a lightoff temperature of the catalyst system is reduced by greater than or equal to about 25° C. compared to a comparative catalyst system having the same amount of platinum group metal bound to an untreated porous aluminum oxide support.

8. The method of claim 1, wherein a lightoff temperature of the catalyst system is reduced by greater than or equal to about 30° C. compared to a comparative catalyst system having the same amount of platinum group metal bound to an untreated porous aluminum oxide support.

9. A catalyst system comprising:
a platinum group metal bound to a stabilized porous aluminum oxide support comprising greater than or equal to about 70% by volume of a stable alumina phase selected from the group consisting of: θ-Al₂O₃, δ-Al₂O₃, and combinations thereof, wherein the stabilized porous aluminum oxide support has an average surface area of greater than or equal to about 50 m²/g to less than or equal to about 150 m²/g.

10. The catalyst system of claim 9, wherein the platinum group metal comprises a metal selected from the group consisting of: platinum (Pt), ruthenium (Ru), rhodium (Rh), palladium (Pd), osmium (Os), iridium (Ir), gold (Au), and combinations thereof.

11. The catalyst system of claim 9, wherein the platinum group metal is a particle having a maximum diameter of greater than or equal to about 1 nm to less than or equal to about 20 nm.

12. The catalyst system of claim 9, wherein the stabilized porous aluminum oxide support has an average pore size diameter of greater than or equal to about 5 nm.

13. The catalyst system of claim 9, wherein the stabilized porous aluminum oxide support has an average pore volume of less than or equal to about 1 cm³/g.

14. The catalyst system of claim 9, wherein the average surface area is less than or equal to about 115 m²/g.

15. The catalyst system of claim 9, wherein a lightoff temperature of the catalyst system is reduced by greater than or equal to about 25° C. compared to a comparative catalyst system having the same amount of platinum group metal bound to an untreated porous aluminum oxide support.

16. The catalyst system of claim 9, wherein a loading density of the platinum group metal on the stabilized porous aluminum oxide support is less than or equal to about 1% (weight/weight).

17. The catalyst system of claim 9, wherein the stable alumina phase is present at greater than or equal to about 90% by volume in the stabilized porous aluminum oxide support.

18. A catalyst system comprising:
a platinum group metal comprising a metal selected from the group consisting of: platinum (Pt), palladium (Pd), rhodium (Rh), and combinations thereof bound to a stabilized porous aluminum oxide support comprising greater than or equal to about 50% by volume of a stable alumina phase selected from the group consisting of: θ-Al₂O₃, δ-Al₂O₃, and combinations thereof, wherein the stabilized porous aluminum oxide support has an average surface area of greater than or equal to about 50 m²/g to less than or equal to about 150 m²/g and a loading density of the platinum group metal on the stabilized porous aluminum oxide support is less than or equal to about 20% (weight/weight).
